(19) United States
(12) Patent Application Publication
(10) Pub. No.: US 2020/0064303 A1
(43) Pub. Date: Feb. 27, 2020

(54) GAS SENSOR ELEMENT

(71) Applicant: DENSO CORPORATION, Kariya-city (JP)

(72) Inventors: Masatoshi IKEDA, Nisshin-city (JP); Shota HAGINO, Nisshin-city (JP); Makoto ITO, Kariya-city (JP); Daisuke KAWAI, Kariya-city (JP)

(21) Appl. No.: 16/547,966

(22) Filed: Aug. 22, 2019

(30) Foreign Application Priority Data
Aug. 23, 2018 (JP) 2018-156178

(51) Int. Cl. G01N 27/407

(52) U.S. Cl. CPC G01N 27/4073; G01N 27/4162; G01N 27/4077; G01N 27/4072

(57) ABSTRACT

In a gas sensor element, an electrolyte layer has a solid electrolyte body having oxygen ionic conductivity. A first insulation body is stacked at a first surface side of the electrolyte layer. A second insulation body is stacked at a second surface side of the electrolyte layer. A measurement gas chamber is surrounded by the electrolyte layer and the first insulation body, into which a detection target gas is introduced. A reference gas chamber is surrounded by the electrolyte layer and the second insulation body, into which a reference gas is introduced. A heater is embedded in the first insulation body. The second insulation body has a low thermal conductivity part having a thermal conductivity which is lower than a thermal conductivity of a heater embedded part formed in the first insulation body in which the heater is embedded.

### CROSS-REFERENCE TO RELATED APPLICATION

This application is related to and claims priority from Japanese Patent Application No. 2018-156178 filed on Aug. 23, 2018, the contents of which are hereby incorporated by reference.

### TECHNICAL FIELD

The present disclosure relates to gas sensor elements.

### BACKGROUND

In general, a gas sensor according to a related art is arranged on an exhaust gas pipe connected to an internal combustion engine. Exhaust gas emitted from an internal combustion engine flows through the exhaust gas pipe. The gas sensor detects a concentration of a specific gas component contained in the exhaust gas flowing in the exhaust gas pipe. The gas sensor according to the related art has a gas sensor element. The gas sensor element has a solid electrolyte body of a plate shape, a measurement electrode and a reference electrode. The measurement electrode is usually formed on one surface of the solid electrolyte body. On the other hand, the reference electrode is formed on the other surface of the solid electrolyte body.

The measurement electrode is arranged in a measurement gas chamber into which exhaust gas as a detection target gas is introduced. The reference electrode is arranged in an atmospheric air introduction chamber into which atmospheric air is introduced.

The measurement gas chamber is surrounded by the solid electrolyte body and a first insulation body. The first insulation body is stacked on one surface of the solid electrolyte body. On the other hand, the atmospheric air introduction chamber is surrounded by the solid electrolyte body, and a second insulation body. The second insulation body is stacked on the other surface of the solid electrolyte body.

The gas sensor element in the gas sensor according to the related art previously described further has a heater. The heater generates heat energy so as to heat the solid electrolyte body not less than its activation temperature. The heater is embedded in the second insulation body formed at the atmospheric air introduction chamber side in the solid electrolyte body.

However, in the gas sensor element previously described, because the heater is embedded in the second insulation body formed at the atmospheric air introduction chamber side, heat energy generated by the heater is easily dissipated into atmospheric air of a relatively low temperature through the atmospheric air introduction chamber. This reduces heat conduction efficiency from the heater to the solid electrolyte body. Accordingly, there is a demand to improve the heat conductive efficiency so as to rapidly activate the solid electrolyte body.

### SUMMARY

It is desired for the present disclosure to provide a gas sensor element having an electrolyte layer, a first insulation body, a second insulation body, a measurement gas chamber, a reference gas chamber and a heater. The electrolyte layer has a solid electrolyte body having oxygen ionic conductivity. The first insulation body is formed at a first surface side of the electrolyte layer. The second insulation body is stacked at a second surface side of the electrolyte layer. The measurement gas chamber is formed and surrounded by the electrolyte layer and the first insulation body, into which a detection target gas is introduced. The reference gas chamber is formed and surrounded by the electrolyte layer and the second insulation body, into which a reference gas is introduced. The heater is embedded in the first insulation body. In particular, the second insulation body has a low thermal conductivity part having a thermal conductivity which is lower than a thermal conductivity of a heater embedded part formed in the first insulation body in which the heater is embedded.

### BRIEF DESCRIPTION OF THE DRAWINGS

A preferred, non-limiting embodiment of the present disclosure will be described by way of example with reference to the accompanying drawings, in which:

FIG. 1 is a view showing a cross section perpendicular to a longitudinal direction, of a gas sensor element, according to a first exemplary embodiment of the present disclosure;

FIG. 2 is a view showing a cross section parallel to the longitudinal direction of the gas sensor element according to the first exemplary embodiment of the present disclosure;

FIG. 3 is an exploded perspective view showing each of layers forming the gas sensor element according to the first exemplary embodiment of the present disclosure;

FIG. 4 is a view showing a partial cross section, parallel to an axial direction, of a gas sensor equipped with the gas sensor element according to the first exemplary embodiment of the present disclosure;

FIG. 5 is a view showing a cross section, which is perpendicular to a longitudinal direction, of the gas sensor element according to a second exemplary embodiment of the present disclosure;

FIG. 6 is a view showing a cross section, which is parallel to the longitudinal direction, of the gas sensor element according to the second exemplary embodiment of the present disclosure;

FIG. 7 is an exploded perspective view showing each of layers forming the gas sensor element according to the second exemplary embodiment of the present disclosure;

FIG. 8 is a view showing a cross section, which is perpendicular to a longitudinal direction, of a gas sensor element according to a third exemplary embodiment of the present disclosure; and

FIG. 9 is an exploded perspective view showing each of layers forming the gas sensor element according to the third exemplary embodiment of the present disclosure;

### DETAILED DESCRIPTION OF THE PREFERRED EMBODIMENTS

Hereinafter, various embodiments of the present disclosure will be described with reference to the accompanying drawings. In the following description of the various embodiments, like reference characters or numerals designate like or equivalent component parts throughout the several diagrams.

### First Exemplary Embodiment

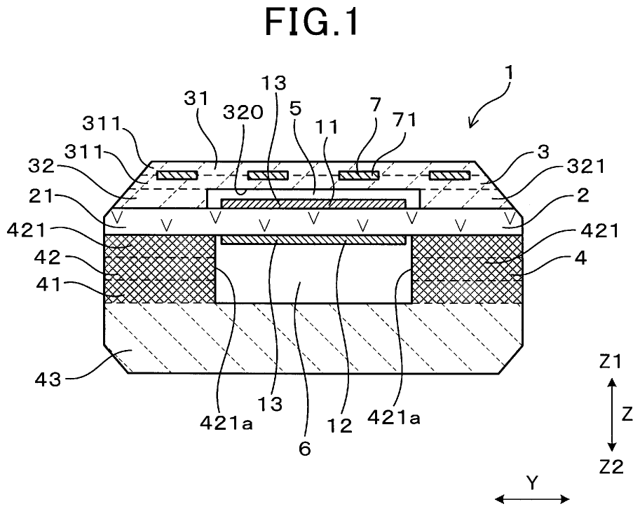

A description will be given of a gas sensor element 1 according to the first exemplary embodiment of the present disclosure with reference to FIG. 1 to FIG. 4.

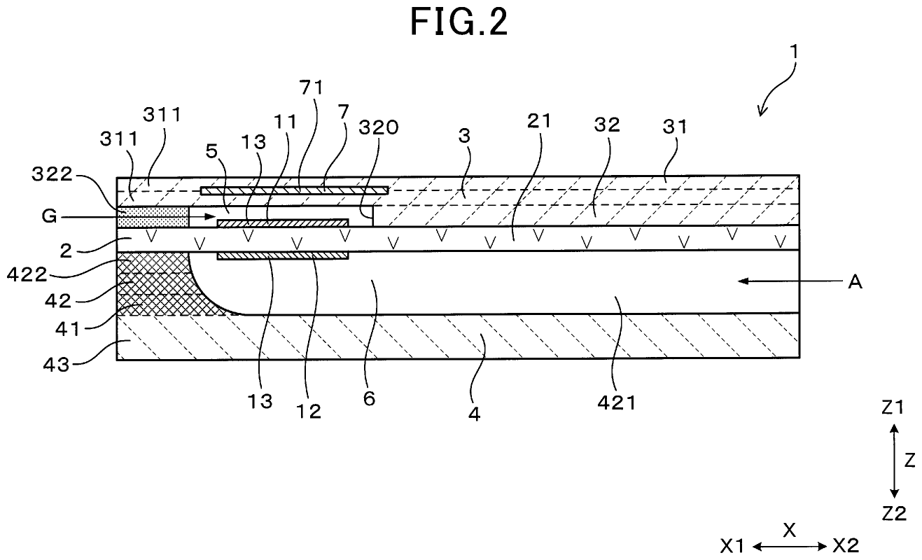

FIG. 1 is a view showing a cross section perpendicular to a longitudinal direction, of the gas sensor element 1, according to the first exemplary embodiment. FIG. 2 is a view showing a cross section parallel to the longitudinal direction of the gas sensor element 1 according to the first exemplary embodiment.

As shown in FIG. 1 and FIG. 2, the gas sensor element 1 according to the first exemplary embodiment has an electrolyte layer 2, a first insulation body 3, a second insulation body 4, a measurement gas chamber 5, a reference gas chamber 6 and a heater 7. The electrolyte layer 2 has a solid electrolyte body 21 having ionic conductivity.

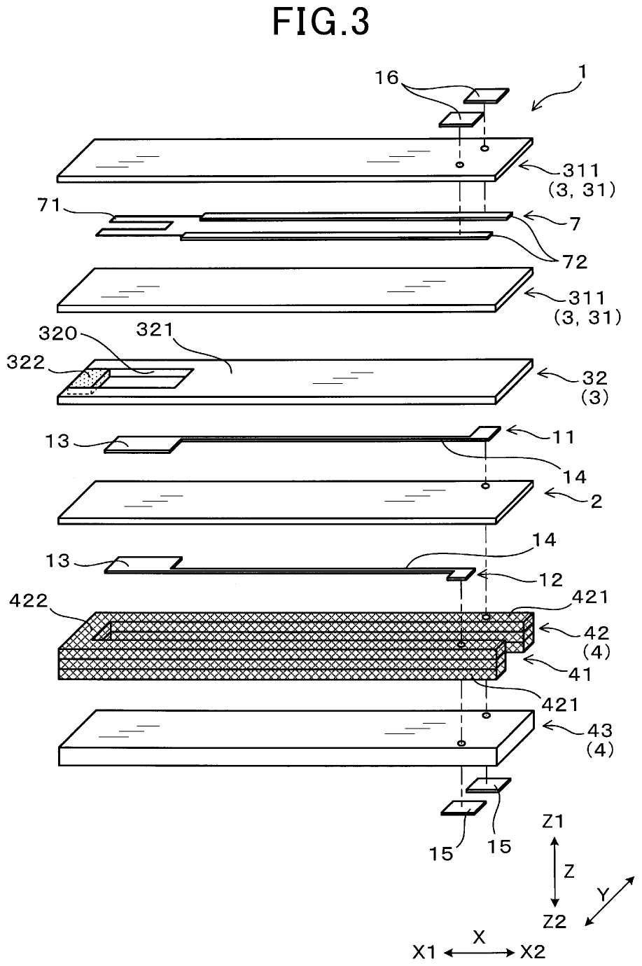

FIG. 3 is an exploded perspective view showing each of layers forming the gas sensor element 1 according to the first exemplary embodiment.

As shown in FIG. 1, FIG. 2 and FIG. 3, the first insulation body 3 is stacked on a first surface of the electrolyte layer 2. On the other hand, the second insulation body 4 is stacked on a second surface of the electrolyte layer 2.

As shown in FIG. 1 and FIG. 2, the measurement gas chamber 5 is surrounded by the electrolyte layer 2 and the first insulation body 3. As shown in FIG. 2, a detection target gas, i.e. exhaust gas G is introduced into the measurement gas chamber 5. The reference gas chamber 6 is surrounded by the electrolyte layer 2 and the second insulation body 4. A reference gas A is introduced into the reference gas chamber 6.

As shown in FIG. 1 and FIG. 2, the heater 7 is embedded in the first insulation body 3. The heater 7 and a surrounding part in which the heater 7 is embedded will be referred to as the heater embedded part 31. In particular, the second insulation body 4 has a low thermal conductivity part 41 which is lower in thermal conductivity than a heater embedded part 31.

A description will be given of the structure and behavior of the gas sensor element 1 in detail.

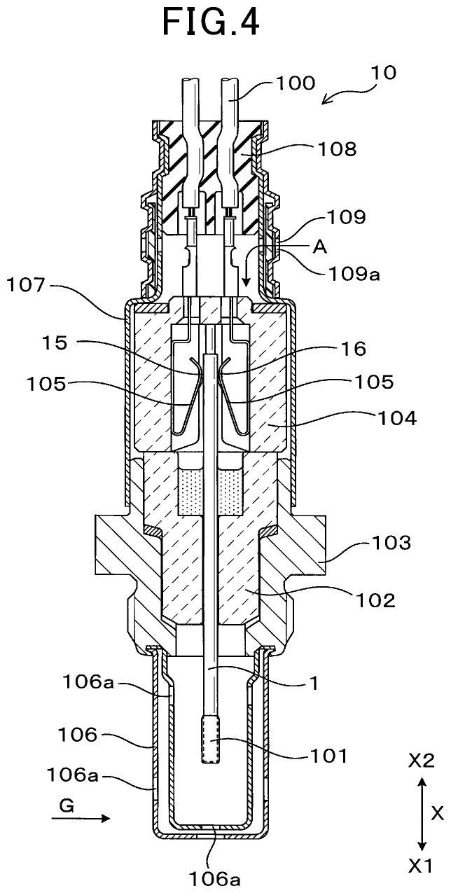

FIG. 4 is a view showing a partial cross section, which is parallel to an axial direction, of the gas sensor 10 equipped with the gas sensor element 1 according to the first exemplary embodiment of the present disclosure.

As shown in FIG. 4, the gas sensor 10 equipped with the gas sensor element 1 is arranged in the exhaust gas pipe (not shown) connected to an internal combustion engine (not shown). The gas sensor 10 detects a concentration of a specific gas contained in exhaust gas as a detection target gas G emitted from the internal combustion engine and flowing in the exhaust gas pipe. For example, the gas sensor 10 detects a concentration of oxygen (i.e. an oxygen concentration) in the detection target gas G on the basis of the atmospheric gas as the reference gas A. The gas sensor 10 is an air/fuel sensor which detects an air fuel ratio (A/F ratio) of the internal combustion engine on the basis of the detected oxygen concentration.

In more specifically, the gas sensor 10 detects a quantitative A/F ratio of the internal combustion engine on the basis of limit current characteristics due to a diffusion limit of the detection target gas G as such exhaust gas.

As shown in FIG. 1, FIG. 2 and FIG. 3, the gas sensor element 1 has a lamination structure in which the first insulation body 3, the electrolyte layer 2 and the second insulation body 4 are stacked in a lamination direction, i.e. their thickness direction (hereinafter, the Z axis). The lamination structure composed of these components is fired and sintered to produce the gas sensor element 1.

When viewed along the Z direction, the first insulation body 3 is formed at a first surface side of the electrolyte layer 2. This first surface side of the electrolyte layer 2 will also be referred to as the Z1 direction side. On the other hand, when viewed along the Z direction, the second insulation body 4 is formed at a second surface side of the electrolyte layer 2. The second surface side of the electrolyte layer 2 will also be referred to as a Z2 direction side.

The longitudinal direction of the gas sensor element 1 will also be referred to as the X direction.

Further, the detection target gas G is introduced at the X1 direction side into the gas sensor element 1, and the reference gas is introduced at the X2 direction side into the gas sensor element 1 in the X direction as the longitudinal direction of the gas sensor element 1.

As shown in FIG. 3, the Y direction is perpendicular to both the X direction and the Z direction. The X direction, the Y direction and the Z direction are perpendicular from each other.

In the structure of the gas sensor element 1 according to the first exemplary embodiment, the electrolyte layer 2 is made of the solid electrolyte body 21 only. The solid electrolyte body 21 has a plate shape along the X direction, and has a thickness in the Z direction. Each of FIG. 2 and FIG. 3 shows a reduced dimension of the gas sensor element 1 in the X direction as compared with an actual dimension of the gas sensor element 1 for ease of understanding.

The solid electrolyte body 21 is made of zirconium oxide. That is, the solid electrolyte body 21 is made of Zirconia (ZrO₂) of not less than 50 mass %, i.e. made of solid electrolyte such as stabilized zirconia or a partially stabilized zirconia, and a part of the zirconia has been replaced with a rare earth metal element or alkaline earth metal element. It is possible to replace a part of zirconia with Yttria (Y₂O), Scandia (Sc₂O₃), or Calcia (CaO), for example.

As shown in FIG. 2, a measurement electrode 11 is arranged in the measurement gas chamber 5 at the X1 direction side and the first surface side (the Z1 direction side) of the solid electrolyte body 21. The measurement electrode 11 is exposed to the detection target gas G such as exhaust gas introduced into the measurement gas chamber 5.

A reference electrode 12 is arranged in the reference gas chamber 6 at the X1 direction side and the second surface side (the Z2 direction side) of the solid electrolyte body 21. The reference electrode 12 is exposed to a reference gas A such as atmospheric gas introduced into the reference gas chamber 6. As shown in FIG. 2, the measurement electrode 11 faces the reference electrode 12 at a facing part 13 through the solid electrolyte body 21 in the Z direction.

As shown in FIG. 3, each of the measurement electrode 11 and the reference electrode 12 is connected to a respective electrode lead part 14 extended from the facing part 13 toward the X2 direction side. That is, both the electrode lead parts 14 are extended from the facing part 13 to the end part of the gas sensor element 1 along the X2 direction side. Both the electrode lead parts 14 are connected through respective through holes formed in the second insulation body 4 to a pair of respective sensor terminals 15 formed at the Z2 direction side on a second surface of the second insulation body 4. The measurement electrode 11 and the reference electrode 12 are electrically connected to an external device (not shown) through the pair of the respective sensor terminals 15.

Each of the measurement electrode 11 and the reference electrode 12 is made of the same material forming the solid electrolyte body 21, i.e. made of zirconium oxide having catalyst activation characteristics to oxygen. In the structure of the gas sensor element 1 according to the first exemplary embodiment, because the solid electrolyte body 21, the measurement electrode 11 and the reference electrode 12 contain the same material, and it is possible to obtain high strength when paste electrode material is plated and then sintered together.

As shown in FIG. 1, FIG. 2 and FIG. 3, the heater embedded part 31 and a chamber formation part 32 are formed in the first insulation body 3 formed at the Z1 side on the first surface of the electrolyte layer 2.

As shown in FIG. 1 and FIG. 2, the chamber formation part 32 is arranged at the Z1 direction side on the first surface of the electrolyte layer 2. The chamber formation part 32 is further formed in the formation part of the measurement gas chamber 5 along the Z direction. The chamber formation part 32 forms the measurement gas chamber 5.

As shown in FIG. 3, the chamber formation part 32 has an insulation spacer part 321 and a diffusion resistance part 322. The chamber formation part 32 has a recess part 320 recessed toward the X2 direction side at an edge part at the X1 direction side of the chamber formation part 32. The diffusion resistance part 322 closed at an opening part in the X1 direction side of the recess part 320.

The insulation spacer part 321 is made of alumina (Al₂O₃) which prevents the detection target gas G from penetrating therein. Similarly, the diffusion resistance part 322 is made of a porous metal oxide such as alumina.

The diffusion resistance part 322 allows the detection target gas G such as exhaust gas to penetrate at a predetermined diffusion rate. Exhaust gas as the detection target gas G is introduced into the inside of the measurement gas chamber 5 through the diffusion resistance part 322. It is possible to form a pinhole as the diffusion resistance part 322, which allows the inside of the measurement gas chamber 5 to communicate with the external atmosphere. It is also acceptable to form the diffusion resistance part 322 at one side or another location in the Y direction of the measurement gas chamber 5.

As shown in FIG. 2, the measurement gas chamber 5 is surrounded and formed by the electrolyte layer 2, the heater embedded part 31, the area surrounded by the insulation spacer part 321 and the diffusion resistance part 322 in the depression part 320.

As shown in FIG. 1 and FIG. 2, the gas sensor element 1 has the structure in which the length in the Z direction of the measurement gas chamber 5 is shorter than a thickness in the Z direction of the electrolyte layer 2. Further, the measurement gas chamber 5 has a structure to accommodate at least the facing part 13 formed in the measurement electrode 11. That is, when viewed in the Z direction, the measurement gas chamber 5 has a size which is greater than the facing part 13 of the measurement electrode 11.

As shown in FIG. 1, FIG. 2 and FIG. 3, the heater embedded part 31 is formed to be stacked at the Z1 direction side of the chamber formation part 32. The heater embedded part 31 is formed at the part in the Z1 direction side close to the gas sensor element 1. The heater embedded part 31 has a pair of embedded plate parts 311 stacked in the Z direction and the heater 7. The heater 7 is embedded between the pair of the embedded plate parts 311.

Similar to the insulation spacer part 321, the embedded plate parts 311 is made of alumina (Al₂O₃) which prevents the detection target gas G from penetrating therein.

As shown in FIG. 3, the heater 7 has heat-energy generation part 71 and a pair of lead parts 72. The pair of the lead parts 72 are connected to the heat energy generation part 71.

As shown in FIG. 1 and FIG. 2, at least some of the heat energy generation parts 71 are arranged at locations which are overlapped in the Z direction with the measurement gas chamber 5. Further, at least some of the heat energy generation parts 71 are arranged at locations which are overlapped in the Z direction with the facing part 13 at which measurement electrode 11 and the reference electrode 12 face with each other. Still further, remaining heat energy generation parts 71 are arranged at locations which are overlapped in the Z direction with the embedded plate parts 311 of the chamber formation part 32.

As shown in FIG. 2, some of the heat energy generation parts 71 are arranged close to the X2 direction side when compared with the location of the measurement gas chamber 5. That is, some of the heat energy generation parts 71 are arranged at locations which are overlapped in the Z direction with a part of the embedded plate parts 311 arranged adjacently with a part at the X2 direction side of the measurement gas chamber 5.

As shown in FIG. 3, the heat energy generation parts 71 are arranged in a curved shape along the X direction in the Y direction.

It is acceptable for the heat energy generation parts 71 to have various shapes. For example, it is acceptable for the heat energy generation parts 71 to be formed in a zigzag shape at both ends in the Y direction extend substantially along the X direction.

As shown in FIG. 3, the pair of the lead parts 72 are connected to both sides of each of the heat energy generation parts 71. The lead parts 72 are formed to the end part at the X2 direction side of the gas sensor element 1. The pair of the lead parts 72 are connected to the pair of heater terminals 16 formed on the surface at the X1 direction side of the embedded plate parts 311. The heater 7 in the gas sensor element 1 is electrically connected to an external device, for example, an external power source.

As shown in FIG. 3, each of the heat energy generation parts 71 is smaller in cross sectional area in its formation direction than the lead parts 72. Further, each of the heat energy generation parts 71 is greater in a resistance value per unit length than the lead parts 72. When a voltage is supplied to the pair of the lead parts 72, the heat energy generation parts 71 generate heat energy, i.e. Joule heat. The solid electrolyte body 21 is activated by the generated heat energy.

As shown in FIG. 1, FIG. 2 and FIG. 3, the second insulation body 4, which is stacked on the second surface at the Z2 direction side of the electrolyte layer 2, has a duct formation part 42 and a support part 43. The support part 43 is formed and arranged on the second surface at the Z2 direction side of the electrolyte layer 2. The duct formation part 42 is arranged in the layer so as to form the reference gas chamber 6.

In the Z direction, the duct formation part 42 is longer in length than the measurement gas chamber 5. After a stacking process of stacking three layers having approximately the same shape in the Z direction, a sintering process is performed to produce the duct formation part 42. However the concept of the present disclosure is not limited by this. For example, it is possible to use a single layer to produce the duct formation part 42. The overall area of the duct formation part 42 is formed by the low thermal conductivity part 41. The low thermal conductivity part 41 is arranged adjacently with the electrolyte layer 2. The low thermal conductivity part 41 is also arranged adjacently with the reference gas chamber 6. In FIG. 1, FIG. 2 and FIG. 3, the low thermal conductivity part 41 is designated by hatching.

In the structure of the gas sensor element 1 according to the first exemplary embodiment, the low thermal conductivity part 41 is made of zirconia of not less than 50 mass %. Zirconia has a thermal conductivity of 3 W/m·K which is lower than alumina of 24 W/m·K. The low thermal conductivity part 41 is made of zirconia, Yttria (Y₂O), Calcium oxide (CaO), Magnesium oxide (MgO), Titania (TiO₂), etc. It is possible to produce the low thermal conductivity part 41 by using porous material having a porosity within a range of 1 to 20%.

As shown in FIG. 3, the duct formation part 42 has a U shape which is open at the X2 direction side. That is, the duct formation part 42 has a pair of long side parts 421 and a short side part 422. The pair of the long side parts 421 are formed along the X direction and faces each other. The end parts at the X1 direction side of the long side parts 421 are connected together through the short side part 422.

As shown in FIG. 2, a surface at the X2 direction side of the short side part 422 has a curved shape which is curved toward the X2 direction side along the Z2 direction side. As shown in FIG. 1 and FIG. 2, the duct formation part 42 is longer in a length of the Z direction than the measurement gas chamber 5.

As shown in FIG. 1 and FIG. 2, the reference gas chamber 6 is surrounded and formed by the electrolyte layer 2, the duct formation part 42 and the support part 43. The low thermal conductivity part 41 (i.e. the duct formation part 42) faces the reference gas chamber 6, and also faces the outer peripheral part of the gas sensor element 1. The reference gas chamber 6 is formed to the end part along the X2 direction of the gas sensor element 1, and has an open part at the X2 direction side. As shown in FIG. 2, atmospheric air as the reference gas A is introduced into the inside of the reference gas chamber 6 through the opening part at the X2 direction side of the duct formation part 42.

As shown in FIG. 1 and FIG. 2, the reference gas chamber 6 is greater in length along the Z direction than the measurement gas chamber 5. In the structure of the gas sensor element 1 according to the first exemplary embodiment, the length of the reference gas chamber 6 is not less than three times of the length of the measurement gas chamber 5. However, the concept of the present disclosure is not limited by this structure.

As shown in FIG. 1, the reference gas chamber 6 is slightly greater in length along the Y direction than the reference electrode 12. The reference electrode 12 is arranged at the middle in the Y direction of the reference gas chamber 6.

As shown in FIG. 2, when viewed in a direction which is perpendicular to the X direction, a cross sectional area of the reference gas chamber 6 at the short side part 422 side is greater than a cross sectional area of the measurement gas chamber 5.

Further, the overall volume of the reference gas chamber 6 is greater than the overall volume of the measurement gas chamber 5. That is, because the reference gas chamber 6 is greater in cross sectional area, length in the Z direction and volume than the measurement gas chamber 5, this structure makes it possible to easily introduce oxygen contained in the reference gas A (i.e. atmospheric air) into the reference gas chamber 6 in which the reference electrode 12 is exposed so as to react unburned gas in the measurement electrode 11.

It is accordingly preferable to form the reference gas chamber 6 having a structure in which the cross sectional area, the length in the Z direction and the volume of the reference gas chamber 6 are greater than those of the measurement gas chamber 5.

As shown in FIG. 1, FIG. 2 and FIG. 3, the support part 43 is stacked at the Z2 direction side on the second surface side of the duct formation part 42. That is, the support part 43 is arranged at the outermost location in the Z2 direction, i.e. the outer peripheral surface of the gas sensor element 1.

As shown in FIG. 1 and FIG. 2, an interior chamber of the duct formation part 42, i.e. the reference gas chamber 6 is closed and sealed with the support part 43 viewed from the Z2 direction side. The support part 43 is made of alumina, which prevents the penetration of the detection target gas G, as the same material forming the insulation spacer part 321 and the embedded plate parts 311.

As shown in FIG. 4, a protection layer 101 is formed on a front part at the X1 direction side of the gas sensor element 1. That is, the front end part of the gas sensor element 1 is covered with the protection layer 101. The protection layer 101 prevents a poisoning material, condensed water, etc. from entering the inside of the gas sensor element 1, where the poisoning material affects the measurement electrode 11 (shown in FIG. 1, FIG. 2 and FIG. 3, for example), and the condensed water is generated in an exhaust gas pipe (not shown). The protection layer 101 is made of porous ceramic (metal oxide) such as alumina.

In the structure of the gas sensor element 1 according to the first exemplary embodiment, the protection layer 101 has a porosity which is greater than a porosity of the diffusion resistance part 322. Further, the detection target gas G, penetrating through the protection layer 101, has a flow amount which is greater than a flow amount of the detection target gas G penetrating through the diffusion resistance part 322.

A description will now be given of the gas sensor 10 equipped with the gas sensor element 1 according to the first exemplary embodiment with reference to FIG. 4.

An axial direction of the gas sensor 10 is coincided with the X direction. In other words, the longitudinal direction of the gas sensor element 1 is in parallel to the axial direction of the gas sensor 10.

The gas sensor 10 has the gas sensor element 1, a first insulator 102, a gas sensor housing 103, a second insulator 104 and a plurality of contact terminals 105.

The first insulator 102 supports the gas sensor element 1. The gas sensor housing 103 supports the first insulator 102. The second insulator 104 is connected to the first insulator 102. The contact terminals 105 are supported by the second insulator 104 and connected to the sensor terminals 15 and the heater terminals 16.

The gas sensor 10 has a front end side cover 106, the second insulator 104, a rear end side cover 107, a bush 108, etc. The front end side cover 106 is fitted to a front side part at the X1 direction side of the gas sensor housing 103. The second insulator 104 is fitted to a rear side part at the X2 direction side of the gas sensor housing 103. The contact terminals 105, etc. are covered with the rear end side cover 107. The bush 107 supports lead wires 100 in the rear end side cover 107.

The front end side cover 106 is arranged to be exposed to the inside of the exhaust gas pipe (not shown) connected to an internal combustion engine (not shown). A part of the gas sensor element 1 is exposed at the X1 direction side to the inside of the front end side cover 106. Gas through holes 106a are formed at the front end side cover 106, through which the detection target gas G such as exhaust gas passes and enters the inside of the gas sensor element 1. It is possible for the front end side cover 106 to have a double cover structure or a single cover structure. The exhaust gas as the detection target gas G, which has entered the inside of the front end side cover 106 from the gas G through holes 106a, is introduced to the measurement electrode 11 through the protection layer 101 and the diffusion resistance part 322 in the gas sensor element 1.

The rear end side cover 107 is arranged at the external location of the exhaust gas pipe connected to the internal combustion engine (not shown). Atmospheric air introduction holes 109 are formed in the rear end side cover 107, through which atmospheric gas as the reference gas A is introduced into the inside of the rear end side cover 107. A filter 109 is arranged in the atmospheric air introduction holes 109 so as to prevent liquid from entering the inside of the rear end side cover 107. The reference gas A, introduced into the rear end side cover 107 through the atmospheric air introduction holes 109, is further introduced to the inside of the reference gas chamber 6 through a gap in the rear end side cover 107. The reference electrode 12 is exposed to the introduced reference gas A.

The contact terminals 105 are formed in the second insulator 104 so as to be connected to the sensor terminals 15 and the heater terminals 16. The lead wires 100 are connected to the contact terminals 105.

The lead wires 100 are connected to a sensor control device (not shown) which controls the gas detection operation of the gas sensor 10. The sensor control device performs the electronic control of the gas sensor 10 cooperating with an engine control device (not shown) which performs a combustion control of the internal combustion engine.

The sensor control device has a current detection circuit, a voltage supply circuit and a heater power supply circuit, etc. The current detection circuit detects a current flowing between the measurement electrode 11 and the reference electrode 12. The voltage supply circuit supplies a voltage between the measurement electrode 11 and the reference electrode 12. The heater power supply circuit supplies an electric power to the heater 7. It is acceptable for the engine control device to have the sensor control device.

A description will now be given of the behavior and effects of the gas sensor element 1 and the gas sensor 10 according to the first exemplary embodiment.

T In the structure of the gas sensor element 1 according to the first exemplary embodiment, because the heater 7 is embedded in the first insulation body 3, this structure makes it possible to avoid the reference gas chamber 6, into which the reference gas A is introduced, from being formed and arranged between the heater 7 and the electrolyte layer 2. This improved structure makes it possible to increase thermal conductivity from the heater 7 to the electrolyte layer 2, and to rapidly activate the solid electrolyte body 21 in the gas sensor element 1.

The second insulation body 4 stacked at the reference gas chamber 6 side of the electrolyte layer 2 has the low thermal conductivity part 41. This structure makes it possible to reduce heat energy discharged from the heater 7 to the second insulation body 4 side by the formation of the low thermal conductivity part 41. This makes it possible to rapidly heat and activate the solid electrolyte body 21.

Further, this structure makes it possible to reduce power consumption of the heater 7 when the solid electrolyte body 21 is rapidly activated to reach it at its activation temperature.

The low thermal conductivity part 41 is made mainly of zirconia. This makes it possible to reduce a thermal conductivity of the low thermal conductivity part 41, and to reduce heat energy provided from the heater 7 to the reference gas A in the reference gas chamber 6 through the second insulation body 4.

Because the low thermal conductivity part 41 is arranged adjacent to the electrolyte layer 2, this makes it possible to suppress heat energy reached to the electrolyte layer 2 from the heater 7 from being transmitted to the reference gas A in the reference gas chamber 6 through the second insulation body 4.

In the structure of the gas sensor element 1 according to the first exemplary embodiment, the low thermal conductivity part 41 is arranged adjacently to the reference gas chamber 6. This structure makes it possible to reduce heat energy to be discharged from the heater 7 to the reference gas A in the reference gas chamber 6 through the second insulation body 4. That is, this makes it possible to rapidly heat and rapidly activate the solid electrolyte body 21.

As previously described in detail, the first exemplary embodiment provides the gas sensor element 1 which rapidly activates the solid electrolyte body 21 therein.

### Second Exemplary Embodiment

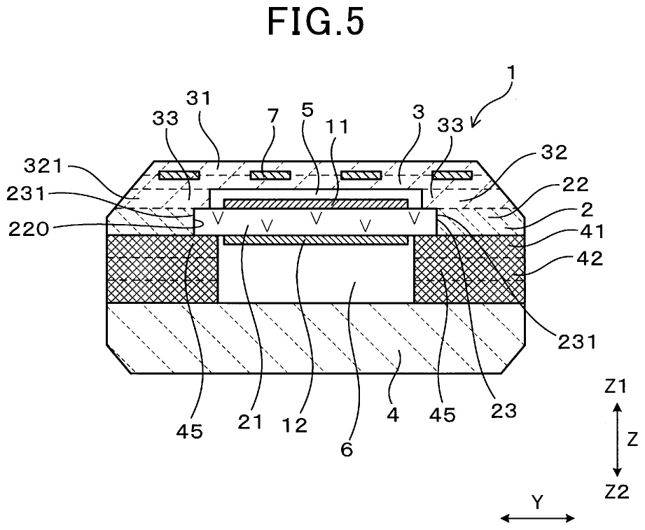

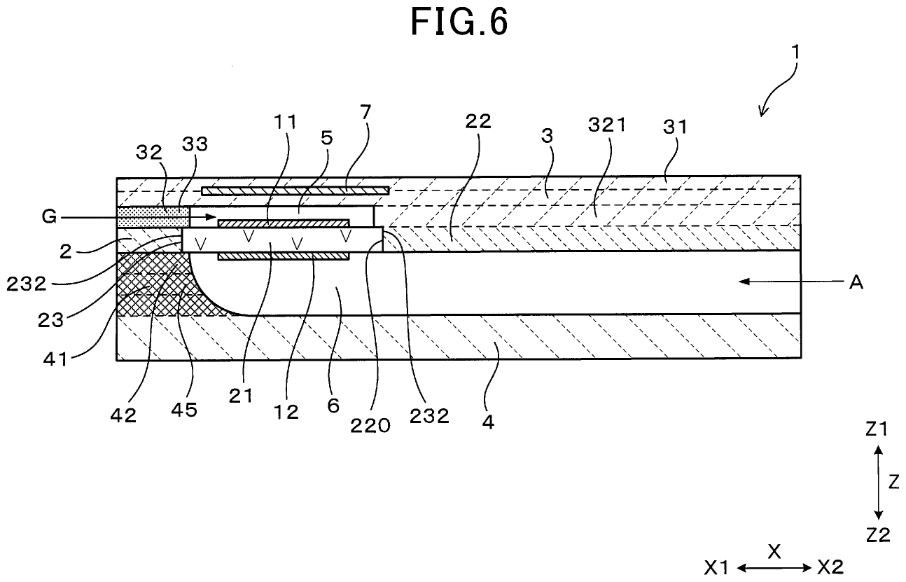

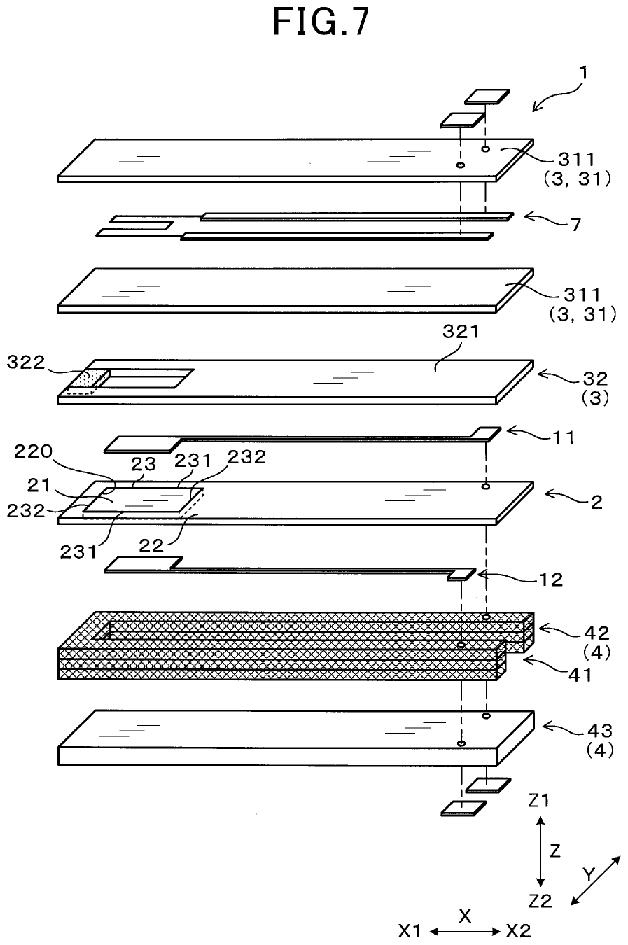

A description will be given of the gas sensor element 1 according to a second exemplary embodiment with reference to FIG. 5, FIG. 6 and FIG. 7. The gas sensor element 1 according to the second exemplary embodiment has the electrolyte layer 2 which is different in structure form the electrolyte layer 2 in the gas sensor element 1 according to the first exemplary embodiment.

FIG. 5 is a view showing a cross section, which is perpendicular to a longitudinal direction, of the gas sensor element 1 according to the second exemplary embodiment of the present disclosure.

In the structure of the gas sensor element 1 according to the second exemplary embodiment shown in FIG. 5, the electrolyte layer 2 has a support plate 22 and the solid electrolyte body 21.

The support plate 22 has an arrangement hole 220 which penetrates through the electrolyte layer 2 in the Z direction, i.e. its thickness direction. As clearly shown in FIG. 5, the solid electrolyte body 21 is arranged in the arrangement hole 220 in the electrolyte layer 2. The support plate 22 has a thermal conductivity which is higher than that of the solid electrolyte body 21. The support plate 22 is made of alumina, which prevents the penetration of the detection target gas G, as the same material forming the insulation spacer part 321.

FIG. 6 is a view showing a cross section, which is parallel to the longitudinal direction, of the gas sensor element 1 according to the second exemplary embodiment of the present disclosure. FIG. 7 is an exploded perspective view showing each of layers forming the gas sensor element 1 according to the second exemplary embodiment of the present disclosure. As shown in FIG. 6 and FIG. 7, the arrangement hole 220 is formed at the X1 direction side in the support plate 22. As shown in FIG. 7, the arrangement hole 220 has a longitudinal rectangle shape along the X direction. As shown in FIG. 5, in the Y direction, the arrangement hole 220 formed in the support plate 22 is greater in size than each of the measurement gas chamber 5 and the reference gas chamber 6. In the Y direction, both end parts of the arrangement hole 220 are arranged outside from each of the measurement gas chamber 5 and the reference gas chamber 6.

As shown in FIG. 6, in the X direction, the end part at the X1 direction side of the arrangement hole 220 is closed to the X1 direction side when compared with each of the measurement gas chamber 5 and the reference gas chamber 6. In the X direction, the end part at the X2 direction side of the arrangement hole 220 is close to the X2 direction side when compared with the measurement gas chamber 5.

As shown in FIG. 5, FIG. 6 and FIG. 7, the arrangement hole 220 is filled with the solid electrolyte body 21. When viewed from the Z direction, the measurement gas chamber 5 is formed to be accommodated in the inside of a boundary part 23. Accordingly, the chamber formation part 32 is formed at the location close the overall boundary part 23 at the Z1 direction side. This structure makes it possible to easily prevent the measurement gas chamber 5 and the reference gas chamber 6 from communicating with each other through the boundary part 23 due to the reduction of the airtightness of the boundary part 23 in the electrolyte layer 2.

As shown in FIG. 5, in the Y direction, both end parts of the reference gas chamber 6 are located at the inside of a pair of first boundary parts 231. The duct formation part 42 is formed to cover the overall area of the pair of the first boundary parts 231 at the Z2 direction side.

As shown in FIG. 6, in the X direction, the edge part at the X1 direction side of the reference gas chamber 6 is arranged, i.e. located at the inside of the boundary part 23.

The duct formation part 42 is formed to cover the overall area of one of a pair of second boundary parts 232 at the X1 direction side, where the pair of the second boundary parts 232 face the boundary part 23 in the X direction. Further, the duct formation part 42 is further formed to cover the overall area of both end parts of the second boundary part 232 at the X2 direction side.

When viewed in the Z direction, the first boundary part 231 has a length which is greater than the length of the second boundary part 232.

As shown in FIG. 5 and FIG. 6, at least a part of the boundary part 23 between the arrangement hole 220 and the solid electrolyte body 21 is supported by a first support part 33 of the first insulation body 3 and a second support part 45 of the second insulation body 4.

The first support part 33 in the first insulation body 3 is formed and arranged at a location which is overlapped in the Z direction with the boundary part 23 and formed on everywhere at which the measurement gas chamber 5 is formed in the Z direction.

Further, the second support part 45 is formed and arranged at a location which is overlapped in the Z direction with the boundary part 23 and formed on everywhere at which the reference gas chamber 6 is formed in the Z direction.

That is, at least a part of the boundary part 23 is sandwiched between the first support part 33 and the second support part 45 having a thickness, for example, which is greater than a length in the Z direction of the measurement gas chamber 5.

As shown in FIG. 5 and FIG. 6, each of the first insulation body 3 and the second insulation body 4 is arranged to support the boundary part 23.

In the boundary part 23, the overall area of at least the pair of the first boundary parts 231 is supported in the Z direction between the first insulation body 3 and the second insulation body 4.

Further, in the boundary part 23, the overall area of one at the X1 direction side of at least the pair of the second boundary parts 232 is supported by the first insulation body 3 and the second insulation body 4. Further, both end parts of the second boundary parts 232 at the X2 direction side are supported by the first insulation body 3 and the second insulation body 4. That is, the overall area of the pair of the first boundary parts 231, and the overall area of the second boundary parts 232 at the X1 direction side, and both the end parts of the second boundary parts 232 at the X2 direction side are sandwiched between the first insulation body 3 and the second insulation body 4 in the Z direction.

The chamber formation part 32 of the first insulation body 3 and the boundary part 23 of the heater embedded part 31 are overlapped in the Z direction at the at the first support part 33.

The duct formation part 42 of the second insulation body 4 and the boundary part 23 of the support part 43 are overlapped in the Z direction at the second support part 45.

The diffusion resistance part 322 forms a part of the first support part 33 which is located at the Z1 direction side of the second boundary part 232 which is located at the X1 direction side.

Other components, designated by the same reference numbers and characters, and behavior of the gas sensor element according to the second exemplary embodiment are the same of those of the gas sensor element according to the first exemplary embodiment. The explanation of the same components is omitted here for brevity.

In the structure of the gas sensor element 1 according to the second exemplary embodiment, the electrolyte layer 2 has the support plate 22 and the solid electrolyte body 21. The support plate 22 has the arrangement hole 220 formed penetrating in the Z direction of the support plate 22. As shown in FIG. 6, the solid electrolyte body 21 is arranged in the arrangement hole 220. The support plate 22 has a thermal conductivity which is greater than that of the solid electrolyte body 21. Accordingly, this structure makes it possible to improve the thermal conductivity of the overall electrolyte layer 2. This structure easily heats the solid electrolyte body 21 with high efficiency by heat energy generated in the heater 7, and rapidly activate the solid electrolyte body 21.

Further, at least a part of the boundary part 23 located between the arrangement hole 220 and the solid electrolyte body 21 is sandwiched between the first support part 33 and the second support part 45. The first support part 33 is formed in the Z direction to be next to the measurement gas chamber 5. The second support part 45 is formed at the overall area in the Z direction to be next of the reference gas chamber 6. That is, at least a part of the boundary part 23 is sandwiched between the first support part 33 and the second support part 45 which are composed of a relatively high rigidity member. Accordingly, this structure prevents the solid electrolyte body 21 from being detaching from the arrangement hole 220.

Still further, because the boundary part 23 is sandwiched between the first support part 33 and the second support part 45, the solid electrolyte body 21 is in contact with the first support part 33 of the first insulation body 3. This structure allows the heat energy generated in the heater 7 to be conducted to the solid electrolyte body 21 through the first support part 33 with high efficiency.

Still further, as shown in FIG. 5, the overall area of at least the pair of the first boundary parts 231 of the boundary part 23 is sandwiched between the first support part 33 and the second support part 45. The overall area of the second boundary part 232 at the X1 direction side in the pair of the first boundary parts 231 of the boundary part 23 is sandwiched between the first support part 33 and the second support part 45. This structure makes it possible for the first support part 33 and the first support part 33 to stably support the boundary part 23, and to prevent the solid electrolyte body 21 from being detaching from the arrangement hole 220.

In addition to the effects previously described, the gas sensor element according to the second exemplary embodiment has the same behavior and effects as the gas sensor element according to the first exemplary embodiment.

### Third Exemplary Embodiment

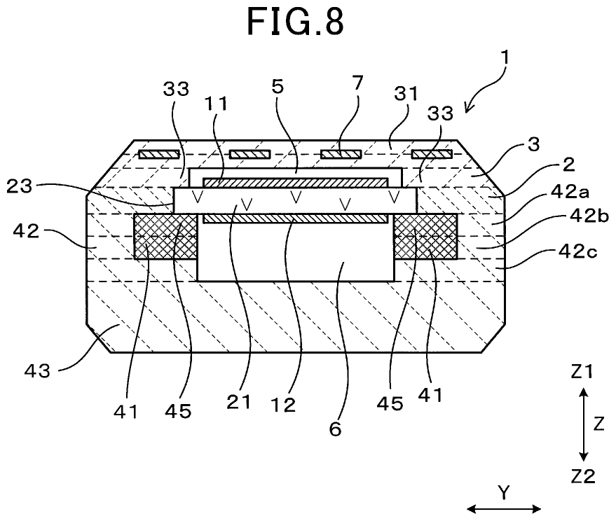

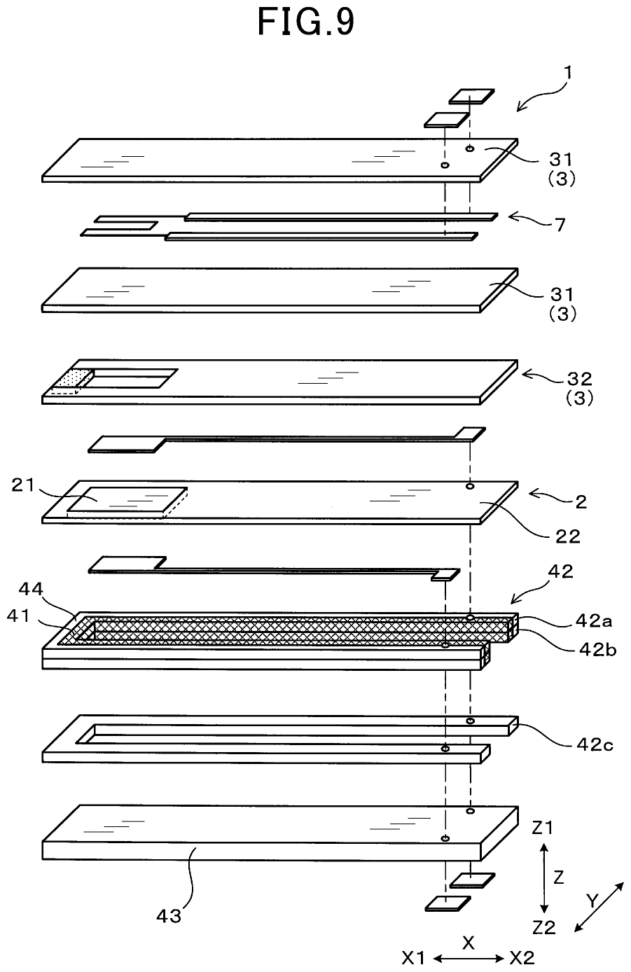

A description will be given of the gas sensor element according to a third exemplary embodiment with reference to FIG. 8 and FIG. 9.

FIG. 8 is a view showing a cross section, which is perpendicular to a longitudinal direction, of the gas sensor element 1 according to the third exemplary embodiment. FIG. 9 is an exploded perspective view showing each of layers forming the gas sensor element 1 according to the third exemplary embodiment.

The gas sensor element 1 according to the third exemplary embodiment shown in FIG. 8 and FIG. 9 has the low thermal conductivity part 41 arranged at a location which is different from the low thermal conductivity part 41 in the gas sensor element according to the second exemplary embodiment shown in FIG. 5, FIG. 6 and FIG. 7.

As shown in FIG. 8 and FIG. 9, the duct formation part 42 is composed of a first layer 42a, a second layer 42b and a third layer 42c stacked in this order from the Z1 direction side. In the structure of the gas sensor element 1 according to the third exemplary embodiment, the low thermal conductivity part 41 is formed in the first layer 42a and the second layer 42b.

As shown in FIG. 9, each of the first layer 42a and the second layer 42b has a U-shape outer peripheral part 44 formed at the outer periphery and the low thermal conductivity part 41 having a U-shape. The low thermal conductivity part 41 is formed along the inner surface of the gas sensor element 1.

Similar to the support part 43 and the support plate 22, the U-shape outer peripheral part 44 and the third layer 42c are made of alumina (Al₂O₃) which prevents the detection target gas G from penetrating therein.

The low thermal conductivity part 41 is arranged to face the reference electrode 6. Similar to the U-shape outer peripheral part 44, the third layer 42c is made of alumina which prevents the detection target gas G from penetrating therein. Other components of the gas sensor element 1 according to the third exemplary embodiment are the same as those of the gas sensor element according to the second exemplary embodiment.

In the structure of the gas sensor element 1 according to the third exemplary embodiment, each of the first layer 42a and the second layer 42b in the duct formation part 42 has the U-shape outer peripheral part 44 and the low thermal conductivity part 41.

The U-shape outer peripheral part 44 is made of the same material, with which both parts of the duct formation part 42 in the X direction. This makes it possible to suppress heat energy generated in the heater 7 from being transmitted toward the reference gas chamber 6, to maintain the connection of the U-shape outer peripheral part 44 with both parts of the duct formation part 42 in the X direction.

In addition to the effects previously described, the gas sensor element according to the third exemplary embodiment has the same behavior and effects as the gas sensor element according to the second exemplary embodiment.

The concept of the present disclosure is not limited by the first, second and third exemplary embodiments previously described in detail. It is possible for the present disclosure to have various modifications.

For example, it is possible for each of the first to third exemplary embodiments to use a concentration cell type gas sensor which detects whether the air fuel ratio (A/F ratio) of a fuel mixture composed of fuel and air, to be supplied to an internal combustion engine, is in a rich state or a lean state. In the rich state of the A/F ratio indicates that a fuel mixture has an excess fuel amount as compared with the Stoichiometric mixture state.

Further, it is possible to apply the concept of the present disclosure to various gas sensors such as a NOx sensor which detects a concentration of NOx contained in exhaust gas, in addition to the A/F sensor explained in the first to third exemplary embodiments. A NOx sensor has a pump electrode and a measurement electrode formed on the surface at the measurement gas chamber on the X1 direction side of the solid electrolyte body. The pump electrode is used to adjust an oxygen concentration in the measurement gas chamber to not more than a predetermined oxygen concentration. The measurement electrode detects a concentration of NOx contained in exhaust gas. In the gas sensor element used in the NOx sensor, a concentration of NOx contained in exhaust gas as the detection target gas is calculated on the basis of a current value flowing between the measurement electrode and the reference electrode which varies due to the concentration of NOx in the detection target gad.

Each of the first, second and third exemplary embodiments has shown the gas sensor element having the low thermal conductivity part 41 made of zirconia. The concept of the present disclosure is not limited by this structure. It is possible for the gas sensor element to have the low thermal conductivity part 41 made of a porous metal oxide such as alumina.

While specific embodiments of the present disclosure have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present disclosure which is to be given the full breadth of the following claims and all equivalents thereof.

What is claimed is:

1. A gas sensor element comprising:
an electrolyte layer comprising a solid electrolyte body having oxygen ionic conductivity;
a first insulation body stacked at a first surface side of the electrolyte layer;
a second insulation body stacked at a second surface side of the electrolyte layer;
a measurement gas chamber formed and surrounded by the electrolyte layer and the first insulation body, into which a detection target gas is introduced;
a reference gas chamber formed and surrounded by the electrolyte layer and the second insulation body, into which a reference gas is introduced; and
a heater embedded in the first insulation body,
wherein
the second insulation body has a low thermal conductivity part having a thermal conductivity which is lower than a thermal conductivity of a heater embedded part formed in the first insulation body in which the heater is embedded.

2. The gas sensor element according to claim 1, wherein
the low thermal conductivity part in the second insulation body is made of zirconia.

3. The gas sensor element according to claim 1, wherein
the electrolyte layer comprises a support plate and the solid electrolyte body,
an arrangement hole is formed in a stack direction in which the solid electrolyte body and the first insulation body are stacked,
the solid electrolyte body is arranged in the arrangement hole, and the support plate has a thermal conductivity which is greater than a thermal conductivity of the solid electrolyte body.

4. The gas sensor element according to claim 2, wherein
the electrolyte layer comprises a support plate and the solid electrolyte body,
an arrangement hole is formed in a stack direction in which the solid electrolyte body and the first insulation body are stacked,
the solid electrolyte body is arranged in the arrangement hole, and the support plate has a thermal conductivity which is greater than a thermal conductivity of the solid electrolyte body.

5. The gas sensor element according to claim 3, wherein
at least a part of a boundary part between the arrangement hole and the solid electrolyte body is sandwiched between a first support part of the first insulation body and a second support part of the second insulation body,
the first support part of the first insulation body is formed at a location which is overlapped with the boundary part in the stack direction, and further formed in an overall area in which the measurement gas chamber is arranged in the stack direction, and
the second support part is formed at a location which is overlapped with the boundary part in the stack direction, and further formed in an overall area in which the reference gas chamber is arranged in the stack direction.

6. The gas sensor element according to claim 4, wherein
at least a part of a boundary part between the arrangement hole and the solid electrolyte body is sandwiched between a first support part of the first insulation body and a second support part of the second insulation body,
the first support part of the first insulation body is formed at a location which is overlapped with the boundary part in the stack direction, and further formed in an overall area in which the measurement gas chamber is arranged in the stack direction, and
the second support part is formed at a location which is overlapped with the boundary part in the stack direction, and further formed in an overall area in which the reference gas chamber is arranged in the stack direction.

7. The gas sensor element according to claim 1, wherein
the low thermal conductivity part is arranged adjacent to the electrolyte layer.

8. The gas sensor element according to claim 2, wherein
the low thermal conductivity part is arranged adjacent to the electrolyte layer.

9. The gas sensor element according to claim 3, wherein
the low thermal conductivity part is arranged adjacent to the electrolyte layer.

10. The gas sensor element according to claim 1, wherein
the low thermal conductivity part is arranged adjacent to the reference gas chamber.

11. The gas sensor element according to claim 2, wherein
the low thermal conductivity part is arranged adjacent to the reference gas chamber.

12. The gas sensor element according to claim 3, wherein
the low thermal conductivity part is arranged adjacent to the reference gas chamber.
